(19) United States
(12) Patent Application Publication
(10) Pub. No.: US 2007/0250422 A1
(43) Pub. Date: Oct. 25, 2007

(54) Method of processing a returned accounts receivable entry

(75) Inventor: Michael Ancell, Kitchener (CA)

Correspondence Address: Michael Chan;Intellectual Property Section, NCR Corporation, 1700 South Patterson Blvd., Dayton, OH, 45479-0001, US

(73) Assignee: NCR Corporation

(21) Appl. No.: 11/406,647

(22) Filed: Apr. 19, 2006

(51) Int. Cl. G06Q 40/00

(52) U.S. Cl. 705/35

(57) ABSTRACT

A computer-implemented method comprises receiving a returned accounts receivable entry, receiving a return reason code associated with the returned accounts receivable entry, locating an image of an original item which corresponds to the returned accounts receivable entry, and routing the image of the original item through a normal image exchange process based upon the return reason code associated with the returned accounts receivable entry. The normal image exchange process may comprise a check image exchange process. The normal image exchange process may comprise an image replacement document (IRD) exchange process.

### BACKGROUND

The present invention relates to accounts receivable (ARC) check conversion, and is particularly directed to a method of processing a returned ARC entry.

A form of check conversion known as ARC check conversion is used by an originator (such as a presenting bank) for the conversion of a customer check received via U.S. mail or at a dropbox location for the payment of goods and services. The customer check payment is processed through a clearing system to provide an electronic debit transaction (ARC entry) drawn on the customer's account. ARC check conversion is regulated by National Automated Clearing House Association (NACHA) rules and Federal Reserve Board Regulations.

From time to time, an ARC entry needs to be returned. When this occurs, a return reason code accompanies the returned ARC entry. As is known, the returned ARC entry is usually either resubmitted for ACH ARC processing or returned to the presenting bank for returning to the customer who presented the check to the presenting bank. Whether the returned ARC entry is resubmitted for ACH ARC processing or returned to the presenting bank depends upon the particular return reason code which accompanied the returned ARC entry. It would be desirable to reduce the number of returned ARC entries which are subsequently returned to presenting customers.

### SUMMARY

In accordance with one aspect of the present invention, a computer-implemented method comprises receiving a returned accounts receivable entry, receiving a return reason code associated with the returned accounts receivable entry, locating an image of an original item which corresponds to the returned accounts receivable entry, and routing the image of the original item through a normal image exchange process based upon the return reason code associated with the returned accounts receivable entry. The normal image exchange process may comprise a check image exchange process. The normal image exchange process may comprise an image replacement document (IRD) exchange process.

In accordance with another aspect of the present invention, a computer-implemented method comprises receiving a returned accounts receivable entry, receiving a return reason code associated with the returned accounts receivable entry, locating an image of an original item which corresponds to the returned accounts receivable entry, and routing the image of the original item through a normal image exchange process when the return reason code associated with the returned accounts receivable entry meets predetermined criteria. The normal image exchange process may comprise a check image exchange process. The normal image exchange process may comprise an image replacement document (IRD) exchange process.

In accordance with yet another aspect of the present invention, a program storage medium is readable by a computer having a memory. The medium tangibly embodies one or more programs of instructions executable by the computer to perform method steps for operating a consolidation server. The method comprises the steps of receiving a returned accounts receivable entry, receiving a return reason code associated with the returned accounts receivable entry, locating an image of an original item which corresponds to the returned accounts receivable entry, and routing the image of the original item through a normal image exchange process based upon the return reason code associated with the returned accounts receivable entry.

### BRIEF DESCRIPTION OF THE DRAWINGS

In the accompanying drawings:

FIG. 1 is a diagram of a consolidation server embodying the present invention; and

FIG. 2 is a flowchart illustrating steps involved in processing a returned accounts receivable (ARC) entry using the consolidation server shown in FIG. 1.

### DETAILED DESCRIPTION

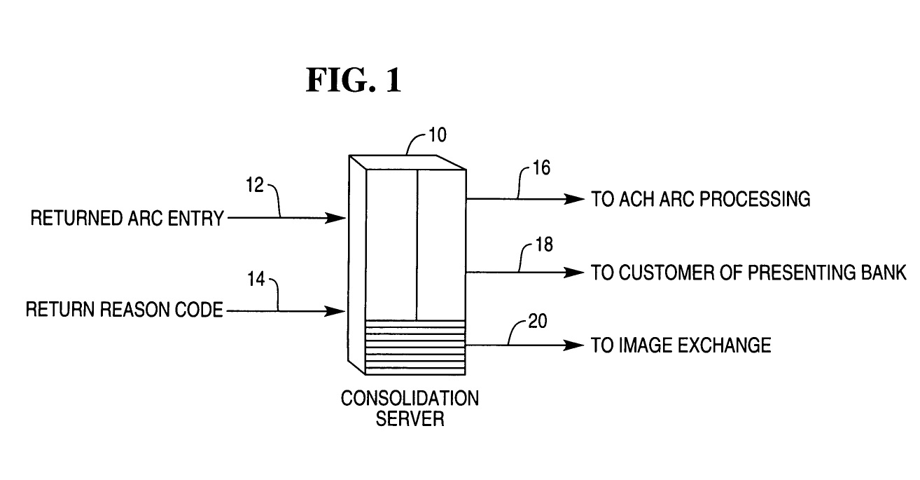

The present invention relates to accounts receivable (ARC) check conversion, and is particularly directed to a method of processing a returned ARC entry. As shown in FIG. 1, a consolidation server 10 receives inputs and provides outputs in accordance with features of the present invention. The server 10 is typically located in the back office facility of a financial institution, such as a bank.

As shown in FIG. 1, the server 10 receives data which identifies a returned ARC entry (as represented by line 12) and data which is representative of a return reason code (as represented by line 14) associated with the returned ARC entry. Although data on line 12 and data on line 14 are represented separately as two different lines, this data could have been represented together as a single line. The ARC entry was originally submitted through the known Automated Clearing House (ACH) ARC processing system. In response to receiving the data on lines 12 and 14, the server 10 processes the data and provides output data on lines 16, 18, and 20 as shown in FIG. 1.

The output data on line 16 is provided when a determination is made that the returned ARC entry is to be resubmitted through the ACH ARC processing system. The output data on line 18 is provided when a determination is made that the returned ARC entry is to be returned to a payor associated with the ARC entry (a presenting bank, for example) so that the presenting bank can, in turn, return the ARC entry to its customer. The output data on line 20 is provided when a determination is made that the returned ARC entry is to be submitted for normal clearing in an image exchange environment which may comprise either a check image exchange or an image replacement document (IRD) exchange.

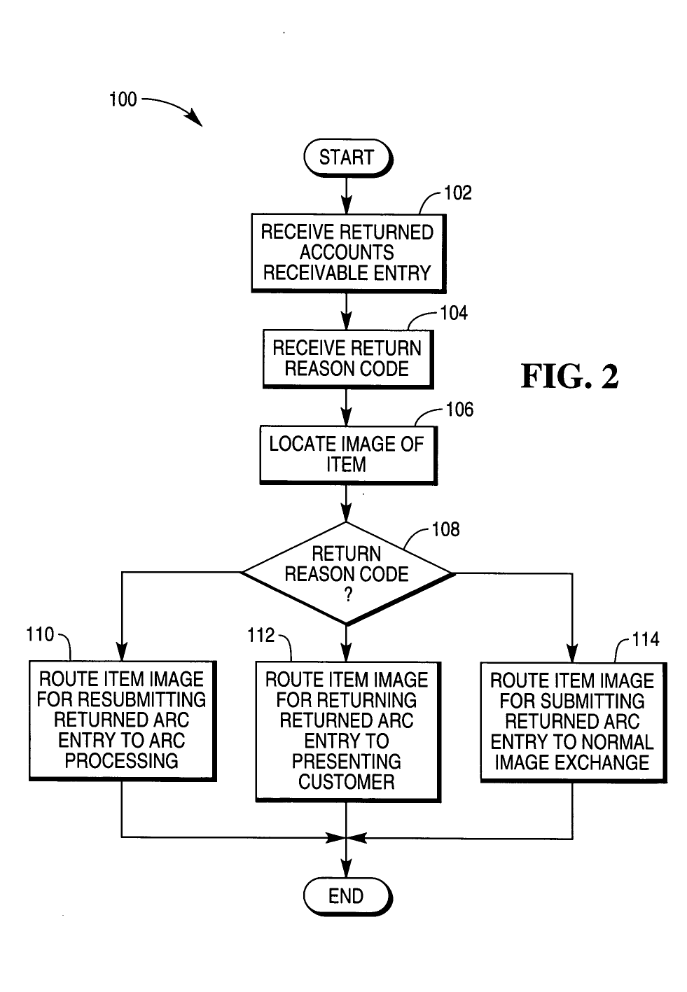

Referring to FIG. 2, a flowchart 100 illustrates typical steps involved in processing a returned ARC entry using the consolidation server 10 shown in FIG. 1. The server 10 receives a returned ARC entry (step 102). The server 10 also receives a return reason code which is indicative of why the ARC entry is being returned (step 104). The server 10 then locates and retrieves an image of an original item which corresponds to the ARC entry which has been returned (step 106). The server 10 may retrieve the item image from either memory located within the server itself or memory located external to the server.

A determination is made based upon the return reason code as to how the retrieved item image from step 106 should be routed (step 108). The retrieved item image is resubmitted for ACH ARC processing (step 110) if the determination is made in step 108 that the item image should be routed as such. Similarly, the retrieved item image is returned to the presenting customer (step 112) if the determination is made in step 108 that the item image should be routed as such. Also, similarly, the retrieved item image is routed to normal image exchange (step 114) if the determination is made in step 108 that the item image should be routed as such. Normal image exchange may comprise either check image exchange or IRD exchange.

The particular arrangements disclosed are meant to be illustrative only and not limiting as to the scope of the invention. From the above description, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

1. A computer-implemented method comprising:
receiving a returned accounts receivable (ARC) entry from an ARC check conversion process;
receiving a return reason code associated with the returned ARC entry;
locating an image of an original item which corresponds to the returned ARC entry; and
routing the image of the original item through a check image exchange process based upon the return reason code associated with the returned ARC entry.

2. (canceled)

3. (canceled)

4. A computer-implemented method comprising:
receiving a returned accounts receivable (ARC) entry from an ARC check conversion process;
receiving a return reason code associated with the returned ARC entry;
locating an image of an original item which corresponds to the returned ARC entry; and
routing the image of the original item through an image replacement document (IRD) exchange process based upon the return reason code associated with the returned ARC entry.

5. (canceled)

6. (canceled)

7. A program storage medium readable by a computer having a memory, the medium tangibly embodying one or more programs of instructions executable by the computer to perform method steps for operating a consolidation server, the method comprising the steps of:
receiving a returned accounts receivable (ARC) entry from an ARC check conversion process;
receiving a return reason code associated with the returned ARC entry;
locating an image of an original item which corresponds to the returned ARC entry; and
routing the image of the original item through either a check image exchange process or an image replacement document (IRD) exchange process based upon the return reason code associated with the returned ARC entry.
